(19) United States
(12) Patent Application Publication
(10) Pub. No.: US 2005/0102846 A1
(43) Pub. Date: May 19, 2005

(54) Guard for reciprocating saw and related method

(76) Inventor: Robert P. Breazeale JR., Baton Rouge, LA (US)

Correspondence Address: SIEBERTH & PATTY, LLC, 4703 BLUEBONNET BLVD, BATON ROUGE, LA, 70809, US

(21) Appl. No.: 10/713,507

(22) Filed: Nov. 14, 2003

(51) Int. Cl. B27B 3/12

(52) U.S. Cl. 30/392; 30/514

(57) ABSTRACT

A guard sized and configured for detachable attachment to a housing of a reciprocating saw, which saw comprises a least one saw blade, wherein the guard forms at least one flexible surface which in turn defines an aperture which extends through the guard and which aperture is sized and configured to allow the blade to extend there through, and wherein the flexible surface contacts the blade when the blade extends through the opening so that a portion of the guard flexes with the movement of the blade to thereby inhibit entry of liquid or particulate debris into the housing when the saw is in use. Reciprocating saws modified with the guard and a method of protecting reciprocating saws from liquid or particulate debris are also provided.

### FIELD OF THE INVENTION

The present invention relates to reciprocating saws and their components.

### BACKGROUND

Reciprocating saws are commonly used to cut or saw objects which have uneven surfaces and/or which vary in thickness. These saws can also be particularly useful in cutting materials which may be moist or have liquid components, e.g., the meat and bone of an animal carcass. However, most modern reciprocating saws are powered by an electrical source such as, e.g., an electrical outlet or a battery, and include moving parts driven by the electrical source. In such instances, inhibiting moisture and related debris, generated when sawing certain objects, from fouling the mechanical and electrical parts has proven to be a challenge.

A need in fact continues to exist for a way to enable the use of electrically-powered reciprocating saws while avoiding the problems associated with moisture and debris generated in certain instances on and around the saw blade during operation of the saw.

### SUMMARY OF THE INVENTION

The present invention is deemed to meeting the foregoing need, amongst others, by providing in one embodiment an article of manufacture which comprises a guard sized and configured for detachable attachment to a housing of a reciprocating saw having at least one saw blade. The guard forms at least one flexible surface which in turn defines an aperture which extends through the guard and which aperture is sized and configured to allow the blade to extend there through. At least a portion of the flexible surface of the guard contacts at least a portion of the blade when the blade extends through the aperture so that a portion of the guard flexes with the movement of the blade to thereby facilitate the maintenance of contact between the blade and the surface in order to inhibit entry of liquid or particulate debris into the housing when the saw is in use.

In another embodiment of the present invention, an apparatus is provided which comprises (A) a reciprocating electrical saw comprising at least one blade extending from a housing; and (B) a guard sized and configured for detachable attachment to the housing of the saw. The guard of this apparatus forms at least one flexible surface which in turn defines an aperture which extends through the guard and which aperture is sized and configured to allow the blade to extend there through. At least a portion of the flexible surface of the guard contacts at least a portion of the blade when the blade extends through the aperture so that at least a portion of the guard flexes with the movement of the blade to thereby inhibit entry of liquid or particulate matter into the housing when the saw is in use.

These and other embodiments, objects, advantages, and features of this invention will now become apparent from the following description, accompanying drawings and appended claims.

### BRIEF DESCRIPTION OF THE DRAWINGS

FIG. 1 is a perspective, partially expanded view of a preferred embodiment of the invention showing a cordless reciprocating saw and a guard aligned for attachment thereto.

FIG. 2 is a plan view of the saw of FIG. 1 showing the guard attached to the housing of the saw.

FIG. 3 is a perspective view of a preferred embodiment of the invention showing the guard detached from the saw.

FIG. 4 is a cross-sectional side view of the guard of FIG. 3, taken generally along a line 4-4 in FIG. 3.

In each of the above figures, like numerals or letters are used to refer to like or functionally like parts among the several figures.

### DETAILED DESCRIPTION OF THE INVENTION

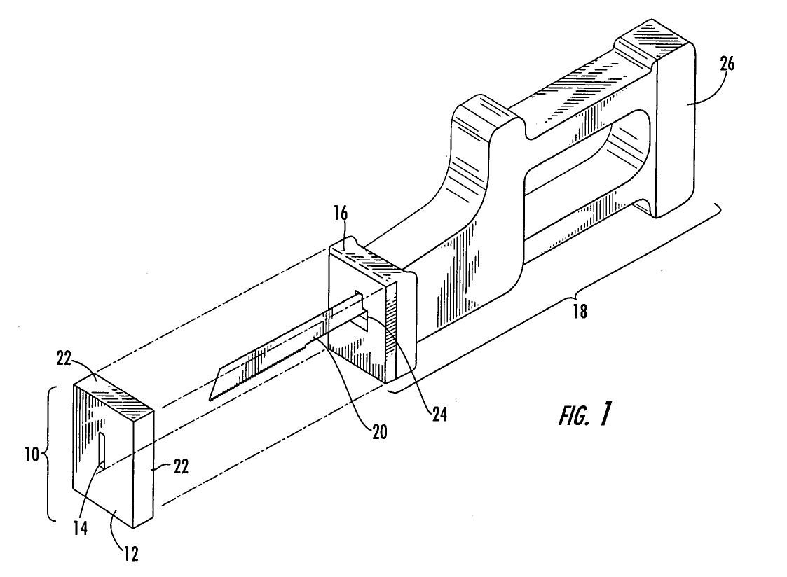

The disclosed invention as depicted in FIGS. 1-4 serves to inhibit or prevent the entry into the interior of a reciprocating saw of liquid such as water or blood and particulate debris such as material found in the area of use of the saw. When a reciprocating saw is used, for example, to clean and dress animal carcasses, small particles of flesh, hair and bone, together with body fluids and water can be drawn into the housing of the saw through the reciprocating action of the blade or blades. The introduction of such foreign material into the housing via the blade receptacle opening can cause damage to the operating parts of the saw, including the saw's mechanical and electrical components. In addition, such foreign material can be a source of bacterial and viral contamination. The present invention can inhibit, greatly reduce or even eliminate such unwanted entry of liquid and particulate debris by serving as a barrier around the base of the blade or blades when the saw is in use. In addition, because the guard is detachable, it is easily cleaned and disinfected between uses.

Turning to a preferred embodiment of the invention as seen in FIG. 1, a detached guard 10 is shown, properly aligned to fit over a saw blade 20 of a cordless electrical reciprocating saw 18. Although, saw 18 is depicted as comprising a single blade, it is to be understood that saw 18 can comprise a plurality of blades. Blade 20 attaches to saw 18 by passing through a blade receptacle opening 24 in a saw motor housing 16 of saw 18. Blade 20 attaches to saw 18 in some conventional manner as may be common in saws of this type, as long as guard 10 can be positioned in sufficiently close proximity to housing 16 so as to substantially cover blade receptacle opening 24. Guard 10, as depicted in this preferred embodiment, comprises a substantially rectangular surface 12 which is flexible. Flexible surface 12 defines an aperture 14 which extends through guard 10. Aperture 14 is sized and configured to allow blade 20 to extend through aperture 14 while maintaining contact between at least a portion of surface 12 and at least a portion of blade 20, especially during operation of saw 18. At least a portion of guard 10 flexes with movement of blade 20 in order to inhibit entry of liquid or particulate matter or debris into housing 16 of saw 18. Saw 18 is shown with a battery 26, which supplies power for saw 18, attached at the rear.

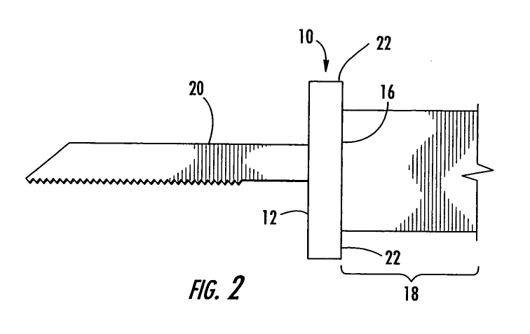

FIG. 2 shows blade 20 extending though aperture 14 (shown best in FIG. 1) with guard 10 attached to housing 16 of saw 18 (shown in its entirety in FIG. 1). Guard 10 further comprises attachment element 22 in the form of a perimeter extension perpendicular to surface 12. Attachment element 22 is form-fitted to fit very tightly over housing 16 thus establishing an essentially friction fit contact between guard 10 and housing 16. As depicted in FIGS. 1 and 2, guard 10 is sized and configured for detachable attachment to housing 16 of reciprocating saw 18 by friction fit action of attachment element 22 against housing 16. Other embodiments of the invention provide that guard 10 is configured to attach to housing 16 in some other manner. Other ways of detachably attaching the guard to the housing can include, but are not limited to, using an adhesive, or hook and loop fastener such as Velcro® fastener.

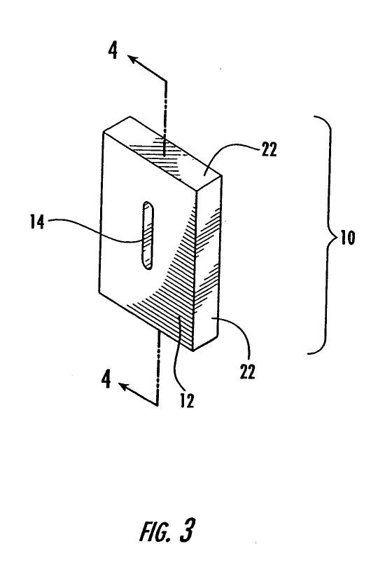

Another preferred embodiment of the invention can be seen in FIG. 3 where guard 10 comprises flexible surface 12 which defines aperture 14. Aperture 14 is sized and configured to allow blade 20 (seen in FIG. 2) to extend there through but with a minimum clearance so that contact is maintained between blade 20 and guard 10. Attachment element 22 can also be seen in this figure as extending perpendicular to surface 12. Attachment element 22 forms a perimeter around flexible surface 12. Of course, it is to be understood that the shape, size and configuration of guard 10 can be varied depending on the size and shape of housing 16 of saw 18, so as to enable a sufficiently precise attachment of guard 10 to housing 16 during use of saw 18 and to ensure guard 10 does not become dislodged during use of saw 18.

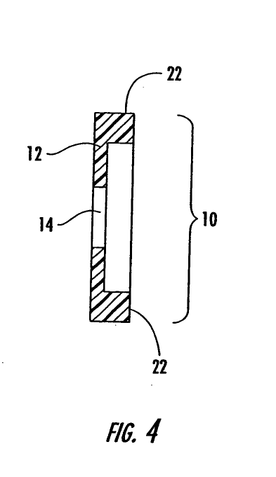

FIG. 4 presents guard 10 of FIG. 3 in cross-section, generally along line 4-4. In FIG. 4 it may be appreciated that, for a preferred embodiment of the invention, the thickness of flexible surface 12 of guard 10 is less than the thickness of attachment element 22. In this embodiment of the invention, the configuration of flexible surface 12 to have a thinner thickness dimension than attachment element 22 is one factor that provides needed flexibility to surface 12 to allow it to remain in contact with blade 20 during operation of saw 18.

It is to be understood, however, that such a difference in dimensions may not be necessary in all embodiments of the invention. For example, when guard 10 is constructed of a material which is sufficiently rigid to serve as a barrier to entry of debris into housing 16 while providing enough flexibility for surface 12 to maintain sufficient contact with blade 20 to provide the barrier, there is no requirement that surface 12 be thinner than attachment element 22.

A preferred embodiment of the invention is a method for protecting a reciprocating saw from liquid or particulate debris generated while a saw blade of the saw works upon an object to be cut. The object to be cut can be, but is not limited to, an animal carcass such as a game animal which requires field-dressing in somewhat unhygienic environments. In this and other applications the method comprises attaching to a housing of the saw a guard so that the saw blade extends through an aperture which extends through the guard. The aperture is sized and configured to allow the blade to extend there through. Though the blade extends through the aperture, the blade remains at least partially in contact with the guard so as to form a barrier which inhibits liquid or debris from passing between the blade and the guard. The method also comprises activating the saw while maintaining the barrier formed between the guard and the blade so that the debris is restricted from entry into the housing of the saw during use of the saw.

Another preferred embodiment of the invention is a kit comprising (A) a reciprocating saw which includes a saw motor housing, and (B) a guard sized and configured for detachable attachment to the housing of the saw, wherein the guard forms at least one flexible surface which in turn defines an aperture which extends through the guard and which aperture is sized and configured to allow the blade to extend there through. At least a portion of the flexible surface contacts at least a portion of the blade when the blade extends through the aperture so that a portion of the guard flexes with the movement of the blade to thereby facilitate the maintenance of contact between the blade and the surface in order to inhibit entry of liquid or particulate matter into the housing when the saw is in use. The kit further comprises, in a preferred embodiment of the invention, at least one blade sized and configured for attachment to the saw and a storage case sized and configured to hold the saw, the at least one blade and the guard, when the saw is not in use. The kit also optionally comprises: a cordless saw powered by a battery; and a battery charger for charging and/or re-charging the battery of the battery-powered saw. The battery charger typically utilizes any conventional 110 volt AC power source. The kit also optionally comprises a saw comprising a plurality of blades.

The case of the kit is preferably small, compact and light weight with space provided therein for the saw, blade or blades, guard and any optional components.

The guard of this invention is formed at least in part from a material consisting of plastic, rubber, synthetic monomer, or synthetic polymer. A preferred material used to form the guard is ethylene propylene diene monomer.

The saw of this invention can comprise a plurality of blades. The blade or blades of the reciprocating saw are constructed of a steel material, and preferably steel containing cobalt.

When an embodiment of the invention employs a cordless reciprocating saw powered by a battery, it is preferred that the voltage of the battery be at least about 18 volts and be able to sustain a charge for at least about one hour of operation of the saw. A reciprocating saw of a preferred embodiment of this invention is the Powerglide model manufactured by World Factory, Inc. of Dallas, Tex.

A surface of a guard of this invention is flexible if it is capable of maintaining at least partial contact with the moving blade of a reciprocating saw when the saw is in use and when the guard is attached to the housing of the saw. Thus, the surface flexes with the movement of the blade. The action of the blade is characterized by movement which does not have great lateral displacement but where the lateral displacement is very rapid. The contact between the guard and the blade serves to inhibit, prevent or restrict entry of liquid or foreign matter or particulate debris into the interior of the saw at the area of attachment of the blade to the saw. This allows the guard to prevent damage which might otherwise occur to the saw's moving and/or electrical components and at least prevent fouling of the saw's motor.

Each and every patent, patent application and printed publication referred to above is incorporated herein by reference in toto to the fullest extent permitted as a matter of law.

It should be appreciated that, while specific embodiments are described hereinafter, several other applications of the presently described invention may be contemplated by those of skill in the art in view of this disclosure. Accordingly, the scope of this invention is not limited to the specific embodiments described in detail hereinafter. Rather, what is intended to be covered is as set forth in the ensuing claims and the equivalents thereof permitted as a matter of law. As used in this specification, means-plus-function clauses, if any, are intended to cover the structures described herein as performing the cited function and not only structural equivalents but also equivalent structures.

1. An article of manufacture which comprises a guard sized and configured for detachable attachment to a housing of a reciprocating saw, which saw comprises a least one saw blade, wherein the guard forms at least one flexible surface which in turn defines an aperture which extends through the guard and which aperture is sized and configured to allow the blade to extend there through, and wherein at least a portion of the flexible surface contacts at least a portion of the blade when the blade extends through the aperture so that at least a portion of the guard flexes with the movement of the blade to thereby facilitate the maintenance of contact between the blade and the surface in order to inhibit entry of liquid or particulate matter into the housing when the saw is in use.

2. An article according to claim 1 wherein the guard is formed at least in part from a material selected from the group consisting of plastic, rubber, synthetic monomer, and synthetic polymer.

3. An article according to claim 2 wherein the guard is formed at least in part from ethylene propylene diene monomer.

4. An article according to claim 1 wherein the saw is a cordless saw powered by a battery.

5. An apparatus comprising:
(A) a reciprocating electrical saw comprising at least one blade extending from a housing; and
(B) a guard sized and configured for detachable attachment to the housing of the saw, wherein the guard forms at least one flexible surface which in turn defines an aperture which extends through the guard and which aperture is sized and configured to allow the blade to extend there through, and wherein at least a portion of the flexible surface contacts at least a portion of the blade when the blade extends through the aperture so that a portion of the guard flexes with the movement of the blade to thereby facilitate the maintenance of contact between the blade and the surface in order to inhibit entry of liquid or particulate matter into the housing when the saw is in use.

6. An apparatus according to claim 5 wherein the guard is formed at least in part from a material selected from the group consisting of plastic, rubber, synthetic monomer, and synthetic polymer.

7. An apparatus according to claim 6 wherein the guard is formed at least in part from ethylene propylene diene monomer.

8. An apparatus according to claim 5 wherein the saw further comprises a plurality of blades.

9. An apparatus according to claim 5 wherein the saw is a cordless saw powered by a battery.

10. A method for protecting a reciprocating saw from liquid or particulate debris generated while a saw blade of the saw works upon an object to be cut, the method comprising:
(1) attaching to a housing of the saw a guard so that the saw blade extends through an aperture which extends through the guard and which aperture is sized and configured to allow the blade to extend there through but to remain at least partially in contact with the guard so as to form a barrier which inhibits the liquid or debris from passing between the blade and the guard; and
(2) activating the saw while maintaining the barrier formed between the guard and the blade so that the debris is restricted from entry into the housing of the saw during use of the saw.

11. A method according to claim 10 wherein the saw further comprises a plurality of blades.

12. A method according to claim 10 wherein the saw is a cordless saw powered by a battery.

13. A kit comprising:
(A) a reciprocating saw which includes a saw motor housing;
(B) a guard sized and configured for detachable attachment to the housing of the saw, wherein the guard forms at least one flexible surface which in turn defines an aperture which extends through the guard and which aperture is sized and configured to allow a saw blade to extend there through, and wherein at least a portion of the flexible surface contacts at least a portion of the blade when the blade extends through the aperture so that a portion of the guard flexes with the movement of the blade to thereby facilitate the maintenance of contact between the blade and the surface in order to inhibit entry of liquid or particulate matter into the housing when the saw is in use.

14. A kit according to claim 13 further comprising at least one blade configured for attachment to the saw.

15. A kit according to claim 14 further comprising a storage case sized and configured to hold the saw, the at least one blade and the guard when the saw is not in use.

16. A kit according to claim 13 wherein the saw is a cordless saw powered by a battery.

17. A kit according to claim 16 wherein the kit further comprises a battery charger for charging the battery.

18. A kit according to claim 17 wherein the storage case is sized configured to hold the saw, the at least one blade, the guard and the battery charger when the saw is not in use.

19. A kit according to claim 13 wherein the saw comprises a plurality of blades.
